(19) United States
(12) Patent Application Publication
(10) Pub. No.: US 2020/0161114 A1
(43) Pub. Date: May 21, 2020

(54) MASS SPECTROMETER AND MASS SPECTROMETRY SYSTEM

(71) Applicant: SHIMADZU CORPORATION, Kyoto-shi (JP)

(72) Inventor: Kiyoshi WATANABE, Kyoto-shi (JP)

(73) Assignee: SHIMADZU CORPORATION, Kyoto-shi (JP)

(21) Appl. No.: 16/598,479

(22) Filed: Oct. 10, 2019

(30) Foreign Application Priority Data
Nov. 19, 2018 (JP) 2018-216737

(51) Int. Cl. H01J 49/02; H01J 49/42

(52) U.S. Cl. CPC H01J 49/025; H01J 49/0027; H01J 49/426; H01J 49/421

(57) ABSTRACT

A connection determiner determines which one of a wired communicator and a wireless communicator an information processing apparatus is connected to. Mass spectrometry of a sample is performed by an analyzer based on an operating instruction given by the connected information processing apparatus. Mass profile data of the sample is acquired by a data acquirer based on a result of analysis by the analyzer. When the connection determiner determines that the information processing apparatus is connected to the wireless communicator, a data amount of the mass profile data acquired by the data acquirer is reduced by a data amount reducer. The mass profile data, the data amount of which has been reduced by the data amount reducer, is transmitted to the information processing apparatus through the wireless communicator by a transmitter.

### BACKGROUND OF THE INVENTION

### Field of the Invention

The present invention relates to a mass spectrometer connectable to an information processing apparatus, and a mass spectrometry system.

### Description of Related Art

An analysis system in which an analysis device and one or more information processing apparatuses are connected to one another by a network has been known. For example, WO 2014/030434 A1 describes an analysis system that includes one or more analysis devices, one or more tablet terminals or one or more PCs (personal computers), a wireless LAN (Local Area Network) and a web browser. The one or more tablet terminals or the one or more PCs are connected to the one or more analysis devices through a wireless LAN.

The analysis device has a firmware that controls itself, a webserver, an application that is embedded upon the webserver and gives an instruction to the firmware. A user gives an instruction to execute the application of the analysis device from the web browser by operating any tablet terminal or any PC. Thus, the application is executed, and an operation of the analysis device is controlled by the firmware.

### BRIEF SUMMARY OF THE INVENTION

Suppose the analysis system described in WO 2014/030434 A1 is configured to use a mass spectrometer. In this case, an information processing apparatus is required to give an operating instruction to a mass spectrometer at a high speed and in real time, and the mass spectrometer is required to transmit data to the information processing apparatus at a high speed and in real time. However, in the mass spectrometer, many types of control objects such as a vacuum gauge, a vacuum pump, an amplifier and a switch for voltage control, and a motor for a stage on which a sample is placed and a camera are provided, and a large volume of data is produced at a high speed. Therefore, realistically, it is not easy to efficiently control the mass spectrometer by the information processing apparatus through the wireless LAN.

An object of the present invention is to provide a mass spectrometer and a mass spectrometry system that can be more efficiently controlled by a wirelessly connected information processing apparatus.

(1) A mass spectrometer according to one aspect of the present invention that displays a mass profile based on mass profile data of a sample and is connectable to an information processing apparatus that analyzes the mass profile data includes a wired communicator that is connectable to the information processing apparatus by wired communication, a wireless communicator that is connectable to the information processing apparatus by wireless communication, a connection determiner that determines which one of the wired communicator and the wireless communicator the information processing apparatus is connected to, an analyzer that carries out mass analysis of the sample based on an operating instruction given by the information processing apparatus, a data acquirer that acquires mass profile data of the sample based on a result of analysis by the analyzer, a data amount reducer that, when the connection determiner determines that the information processing apparatus is connected to the wireless communicator, reduces a data amount of the mass profile data acquired by the data acquirer, and a transmitter that transmits the mass profile data, the data amount of which has been reduced by the data amount reducer, to the information processing apparatus through the wireless communicator.

In this mass spectrometer, the connection determiner determines which one of the wired communicator and the wireless communicator the information processing apparatus is connected to. The mass spectrometry of the sample is carried out by the analyzer based on the operating instruction given by the connected information processing apparatus. The mass profile data of the sample based on the result of analysis by the analyzer is acquired by the data acquirer. When the connection determiner determines that the information processing apparatus is connected to the wireless communicator, the data amount of the mass profile data acquired by the data acquirer is reduced by the data amount reducer. The mass profile data, the data amount of which has been reduced by the data amount reducer, is transmitted to the information processing apparatus by the transmitter through the wireless communicator.

With this configuration, when the information processing apparatus is connected to the mass spectrometer through the wireless communicator, the data amount of the mass profile data transmitted from the mass spectrometer to the information processing apparatus is reduced. Therefore, even when the large volume of the mass profile data is acquired by the data acquirer at a high speed, the large volume of the mass profile data is prevented from being transmitted from the mass spectrometer to the information processing apparatus. Therefore, even at the restricted communication speed of the wireless communication, the transmission of the operating instruction from the information processing apparatus to the mass spectrometer is not prevented. Thus, the information processing apparatus can give the operating instruction to the mass spectrometer at a high speed and in real time, and the mass spectrometer can transmit the mass profile data to the information processing apparatus at a high speed and in real time. As a result, the mass spectrometer can be more efficiently controlled by the wirelessly connected information processing apparatus.

(2) The data amount reducer may reduce the data amount by compressing or thinning the mass profile data. In this case, the data amount of the mass profile data can be easily reduced.

(3) The information processing apparatus may be configured to be able to designate a mass range of the mass profile to be displayed, and the data amount reducer may determine a percentage of thinning of the mass profile data based on the mass range designated by the information processing apparatus and resolution of a display of the mass profile. In this case, the mass profile can be displayed in the information processing apparatus in the required mass range without degradation of resolution.

(4) The information processing apparatus may include a PC (Personal Computer) or a mobile terminal. In this case, it is possible to carry out advance analysis on the mass profile data by using the PC as the information processing apparatus. Further, the user can communicate with the mass spectrometer while moving by using the mobile terminal as the information processing apparatus.

(5) The connection determiner may further determines whether the information processing apparatus connected to the wired communicator or the wireless communicator is the PC or the mobile terminal, and the data amount reducer, when the connection determiner determines that the information processing apparatus is the mobile terminal, may reduce the data amount of the mass profile data acquired by the data acquirer. With this configuration, even when the processing speed of the mobile terminal is restricted, the information processing apparatus can give the operating instruction to the mass spectrometer at a high speed and in real time, and the mass spectrometer can transmit the data to the information processing apparatus at a high speed and in real time. Thus, the mass spectrometer can be more efficiently controlled by the mobile terminal.

(6) The PC and the mobile terminal may display a same GUI (Graphical User Interface) that receives a user's operation. With this configuration, even when either one of the PC and the mobile terminal is connected to the mass spectrometer, the user can operate the PC or the mobile terminal with the same operability.

(7) The information processing apparatus may restrict contents to be displayed in the GUI or contents of an operation to be received from the GUI according to performance of the information processing apparatus. In this case, the information processing apparatus can efficiently analyze the mass profile data according to the performance of the information processing apparatus.

(8) The information processing apparatus may include a touch panel that receives a user's touch operation performed on the GUI. In this case, the operability of the GUI can be more sufficiently improved.

(9) The analyzer may further include an imager that produces image data by imaging a sample, the data acquirer further acquires image data produced by the imager, the data amount reducer, when the connection determiner determines that the information processing apparatus is connected to the wireless communicator, may further reduce a data amount of the image data acquired by the data acquirer, and the transmitter may further transmit the image data, the data amount of which has been reduced by the data amount reducer, to the information processing apparatus through the wireless communicator.

In this case, the image of the sample can be displayed in the information processing apparatus based on the image data. Further, when the information processing apparatus is connected to the mass spectrometer through the wireless communicator, the data amount of the image data transmitted from the mass spectrometer to the information processing apparatus is reduced. Thus, the information processing apparatus can give the operating instruction to the mass spectrometer at a high speed and in real time, and the mass spectrometer can transmit the image data to the information processing apparatus at a high speed and in real time. As a result, the mass spectrometer can be more efficiently controlled by wirelessly connected information processing apparatus.

(10) The mass spectrometer may further include a connection component to which an operation unit that receives a user's operation and a display that displays the mass profile based on the mass profile data of the sample are connectable, wherein the analyzer may carry out mass analysis of the sample based on the operation received by the operation unit, and the connection component may supply the mass profile data acquired by the data acquirer to the display. In this case, even when the information processing apparatus is not connected to the mass spectrometer, the operating instruction can be given to the mass spectrometer by the operation unit. Further, the mass profile can be displayed in the display based on the mass profile data of the sample.

(11) A mass spectrometry system according to another aspect of the present invention includes one or more information processing apparatuses that display a mass profile based on mass profile data of a sample and analyzes the mass profile data, and the mass spectrometer according to the one aspect of the present invention that is connected to the one or more information processing apparatuses by wired communication or wireless communication, performs mass analysis of the sample based on an operating instruction from one of the one or more information processing apparatuses, and transmits mass profile data of the sample based on a result of analysis to the information processing apparatus.

In this mass spectrometry system, the one or more above-mentioned information processing apparatuses are connected to the one or more above-mentioned information processing apparatuses by wired communication or wireless communication. In each information processing apparatus, the mass profile is displayed based on the mass profile data of the sample supplied from the mass spectrometer, and the mass profile data is analyzed.

In the mass spectrometer, when the information processing apparatus is connected to the mass spectrometer through the wireless communicator, the data amount of the mass profile data transmitted from the mass spectrometer to the information processing apparatus is reduced. Therefore, even when the large volume of the mass profile data is acquired at a high speed, the large volume of the mass profile data is prevented from being transmitted from the mass spectrometer to the information processing apparatus. Therefore, even at the restricted communication speed of the wireless communication, transmission of the operating instruction from the information processing apparatus to the mass spectrometer is not prevented. Thus, the information processing apparatus can give the operating instruction to the mass spectrometer at a high speed and in real time, and the mass spectrometer can transmit the mass profile data to the information processing apparatus at a high speed and in real time. As a result, the mass spectrometer can be more efficiently controlled by the wirelessly connected information processing apparatus.

(12) The connection between the mass spectrometer and the one or more information processing apparatuses may be physically separated from an information processing apparatus outside of the mass spectrometry system. In this case, the information processing apparatus outside of the mass spectrometry system can be easily prevented from being connected to the mass spectrometer.

Other features, elements, characteristics, and advantages of the present invention will become more apparent from the following description of preferred embodiments of the present invention with reference to the attached drawings.

### BRIEF DESCRIPTION OF THE SEVERAL VIEWS OF THE DRAWING

FIG. 1 is a diagram showing the configuration of a mass spectrometry system according to one embodiment of the present invention;

FIG. 2 is a diagram showing the configuration of a control device of FIG. 1;

FIG. 3 is a flow chart showing the algorithm of control processing of a mass spectrometer performed by the control device;

FIG. 4 is a diagram showing the configuration of a mass spectrometry system according to a modified example; and

FIG. 5 is a flow chart showing the algorithm of control processing in another embodiment.

### DESCRIPTION OF THE PREFERRED EMBODIMENTS

### (1) CONFIGURATION OF MASS SPECTROMETRY SYSTEM

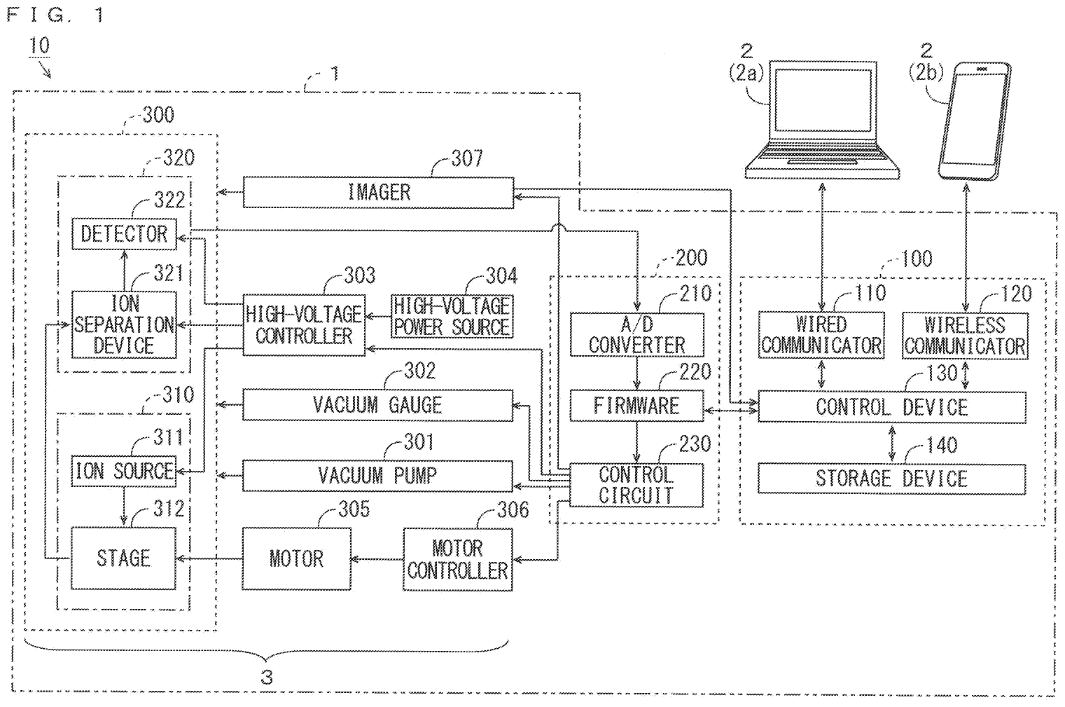

A mass spectrometer and a mass spectrometry system according to an embodiment of the present invention will be described below in detail with reference to drawings. FIG. 1 is a diagram showing the configuration of the mass spectrometry system according to the one embodiment of the present invention. As shown in FIG. 1, the mass spectrometry system 10 is constituted by a mass spectrometer 1, and one or more information processing apparatuses 2, which are clients. The mass spectrometry system 10 may include one or more mass spectrometers 1. The mass spectrometer 1 and each information processing apparatus 2 are connected to each other by a LAN (Local Area Network).

Each information processing apparatus 2 may be a desktop or laptop PC (Personal Computer) 2a, or may be a movable mobile terminal 2b such as a tablet terminal or a smartdevice. In this case, it is possible to carry out advanced analysis on mass profile data by using the PC 2a as the information processing apparatus 2. Further, a user can communicate with the mass spectrometer 1 while moving by using the mobile terminal 2b as the information processing apparatus 2.

In the present embodiment, the PC 2a is connected to the mass spectrometer 1 through a wired LAN, and the mobile terminal 2b is connected to the mass spectrometer 1 through a wireless LAN. The connection made by the wireless LAN may be ad-hoc communication or connection made through an access point. The connection between the mass spectrometer 1 and each information processing apparatus 2 is physically separated from external information processing apparatuses. Therefore, an information processing apparatus outside of the mass spectrometry system 10 can be easily prevented from being connected to the mass spectrometer 1.

In each information processing apparatus 2, software for displaying a GUI (Graphical User Interface) and software for analyzing mass profile data are installed. The analysis of data includes advanced analysis such as search of database or data identification. Because advanced analysis can be carried out by the information processing apparatus 2, a control device 130 of a server 100, described below, can be constituted by a small-size PC or a small-size CPU (Central Processing Unit) substrate.

In the present embodiment, the above-mentioned software is native application software, and enables the same GUI or the same analysis screen to be displayed in the PC 2a and the mobile terminal 2b. With this configuration, even when either one of the PC 2a and the mobile terminal 2b is connected to the mass spectrometer 1, the user can operate the PC 2a or the mobile terminal 2b with the same operability. The user can supply an analysis procedure, an analysis method or the like to the information processing apparatus 2 in real time by operating the GUI of one of the information processing apparatuses 2.

Each information processing apparatus 2 transmits an operating instruction to the mass spectrometer 1 based on the analysis procedure, the analysis method or the like that is received by the GUI. Further, the information processing apparatus 2 receives various data including mass profile data and image data from the mass spectrometer 1. Here, processing of reducing a data amount is performed on the mass profile data received by the information processing apparatus 2 (the mobile terminal 2b in the present example) connected through the wireless LAN. The information processing apparatus 2 allows the GUI to display a mass profile, an image of a sample or the like based on the received data.

Extended functions corresponding to the performance of the information processing apparatus 2 may be provided in the GUI. In this case, analysis can be efficiently carried out on the mass profile data according to the performance of the information processing apparatus 2. For example, in the information processing apparatus 2 having high performance, a high-resolution GUI may be displayed or a plurality of GUIs may be displayed simultaneously, and more advanced analysis may be carried out on the mass profile data. On the other hand, in the information processing apparatus 2 having relatively low performance, the contents to be displayed in the GUI or contents to be received by the GUI may be restricted.

Alternatively, when a touch panel is provided at the information processing apparatus 2, a user's touch operation may be received by the GUI. The touch operation includes a swipe operation for scrolling a display region of the GUI, a pinch-out operation for zooming in the display region of the GUI, a pinch-in operation for zooming out the display region of the GUI or the like. In this case, operability of the GUI can be more sufficiently improved.

The mass spectrometer 1 is constituted by the server 100, a control substrate 200 and a vacuum chamber 300. The server 100 includes a wired communicator 110, a wireless communicator 120, the control device 130 and a storage device 140.

The wired communicator 110 is an interface for connecting the mass spectrometer 1 to the wired LAN. The wired communicator 110 receives an operating instruction from the PC 2a through the wired LAN and transmits various data that have been acquired or processed by the control device 130 to the PC 2a. The wireless communicator 120 is an interface for connecting the mass spectrometer 1 to the wireless LAN. The wireless communicator 120 receives an operating instruction from the mobile terminal 2b through the wireless LAN, and transmits various data that have been acquired or processed by the control device 130 to the mobile terminal 2b.

As described above, the control device 130 is constituted by the small-size PC or the small-size CPU substrate, and gives an instruction for control of controlled objects, described below, measurement control, batch measurement control or the like to the control substrate 200 based on the operating instruction received by the wired communicator 110 or the wireless communicator 120. Further, the control device 130 acquires various data including mass profile data and image data from the control substrate 200 and the controlled subject, and performs processing on the acquired mass profile data. The data processing includes peak detection, waveform processing such as filtering, or the like. Further, the control device 130 allows the storage device 140 or a storage device outside of the mass spectrometer 1 to store the acquired or processed data.

The control substrate 200 includes an A/D (Analogue/Digital) converter 210, a firmware 220 and a control circuit 230. For example, the A/D converter 210 includes a high-speed and high-resolution digitizer, repeatedly acquires a detection signal, described below, from the vacuum chamber 300 and converts the acquired detection signal into a digital signal.

The firmware 220 is realized by a real-time OS (Operating System) and controls an operation of the controlled object in real time through the control circuit 230 based on an instruction given from the server 100. Further, the firmware 220 produces a large volume of mass profile data at a high speed based on the digital signal converted by the A/D converter 210.

A sample chamber 310 and an analysis chamber 320 are arranged in the vacuum chamber 300. An ion source 311 and a stage 312 are provided in the sample chamber 310. The ion source 311 includes a laser light source, for example, and ionizes the sample to be analyzed in the sample chamber 310 by MALDI (Matrix Assisted Laser Desorption/lonization) or the like. The sample to be analyzed is placed on the stage 312. The stage 312 is an XY stage that is movable in two directions orthogonal to each other in a horizontal plane, and introduces ions into the analysis chamber 320 by moving from the sample chamber 310 to the analysis chamber 320 after the ionization of the sample.

An ion separation device 321 and a detector 322 are provided in the analysis chamber 320. The ion separation device 321 includes an ion trap and TOFMS (Time-Of-Flight Mass Spectrometry), for example, and separates the ions introduced by the stage 312 into groups respectively including ions of certain mass values. The detector 322 is a secondary electron multiplier tube, for example, sequentially detects the ions separated by the ion separation device 321 at different times according to the mass values of the ions, and supplies an analogue detection signal indicating detection intensity to the control substrate 200.

Further, the vacuum chamber 300 is provided with a vacuum pump 301, a vacuum gauge 302, a high-voltage controller 303, a high-voltage power supply 304, a motor 305, a motor controller 306 and an imager 307. An analyzer 3 is constituted by the vacuum chamber 300, the vacuum pump 301, the vacuum gauge 302, the high-voltage controller 303, the high-voltage power supply 304, the motor 305, the motor controller 306 and the imager 307. The vacuum pump 301, the vacuum gauge 302, the high-voltage controller 303, the motor controller 306 and the imager 307 are controlled by the control substrate 200 as controlled objects.

The vacuum pump 301 vacuums the inside of the vacuum chamber 300 at the time of activation of the mass spectrometer 1. The vacuum gauge 302 measures the vacuum level (pressure value) inside of the vacuum chamber 300. The high-voltage controller 303 includes an amplifier, a switch and the like, and supplies a high voltage generated by the high-voltage power supply 304 to the ion source 311, the ion separation device 321 and the detector 322 at the time of the ionization of a sample and separation of ions.

The motor 305 moves the stage 312 from the sample chamber 310 to the analysis chamber 320 based on the control by the motor controller 306 after the ionization of the sample on the stage 312. The imager 307 includes an observation optical system such as a camera, produces image data representing an image of the sample by imaging the sample in the vacuum chamber 300, and supplies the produced image data to the server 100.

### (2) CONTROL PROCESSING

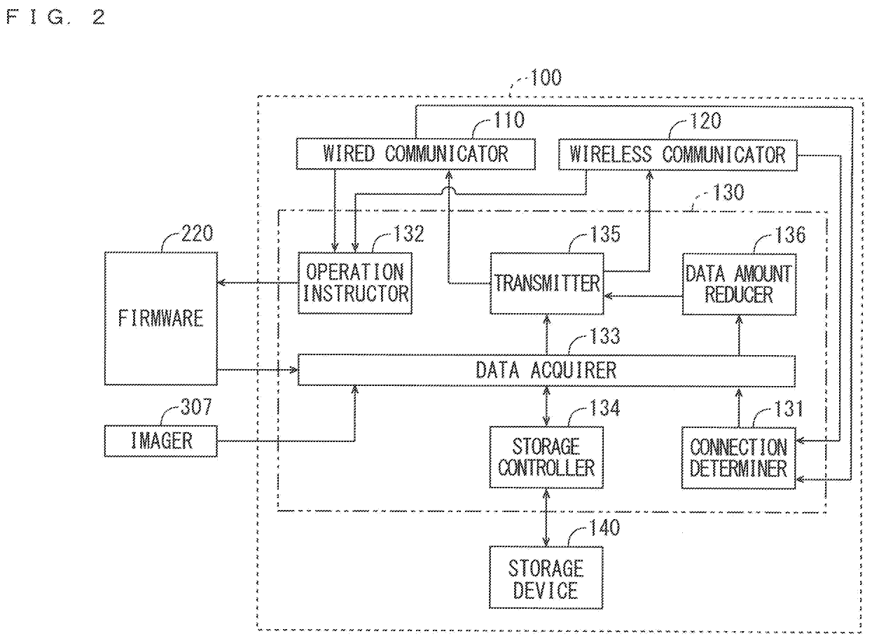

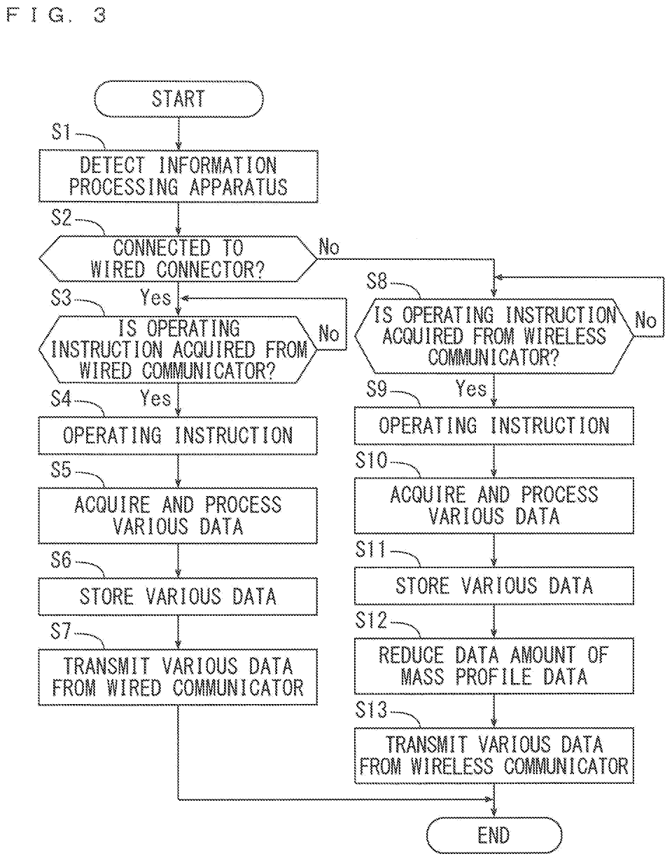

FIG. 2 is a diagram showing the configuration of the control device 130 of FIG. 1. FIG. 3 is a flow chart showing the algorithm of the control processing of the mass spectrometer 1 performed by the control device 130. As shown in FIG. 2, the control device 130 includes a connection determiner 131, an operation instructor 132, a data acquirer 133, a storage controller 134, a transmitter 135 and a data amount reducer 136 as functions.

A control program of the mass spectrometer 1 is stored in the storage device 140. The control device 130 executes the control program stored in the storage device 140, so that the functions of the control device 130 are realized. Part or all of the functions of the control device 130 may be realized by hardware such as an electronic circuit. The control processing of the mass spectrometer 1 will be described below with reference to the control device 130 of FIG. 2 and the flow chart of FIG. 3.

First, the connection determiner 131 detects the information processing apparatus 2 connected to the wired communicator 110 or the wireless communicator 120 (step S1). Further, the connection determiner 131 determines whether the information processing apparatus 2 detected in the step S1 is connected to the wired communicator 110 (step S2). When the information processing apparatus 2 is connected to the wired communicator 110, the connection determiner 131 proceeds to the step S3. On the other hand, when the information processing apparatus 2 is not connected to the wired communicator 110, that is, when the information processing apparatus 2 is connected to the wireless communicator 120, the connection determiner 131 proceeds to the step S8.

Connection of the information processing apparatus 2 to the wired communicator 110 means that the information processing apparatus 2 detected in the step S1 is connected by the wired LAN. Connection of the information processing apparatus 2 to the wireless communicator 120 means that the information processing apparatus 2 detected in the step S1 is connected by the wireless LAN.

When the information processing apparatus 2 is connected to the wired communicator 110 in the step S2, the operation instructor 132 determines whether an operating instruction is acquired from the wired communicator 110 (step S3). When an operating instruction is not acquired, the operation instructor 132 waits until the operating instruction is acquired. When the operating instruction is acquired, the operation instructor 132 gives the operating instruction to the firmware 220 (step S4).

Thereafter, the data acquirer 133 acquires various data and processes the acquired data (step S5). Various data includes mass profile data acquired from the firmware 220 and image data acquired from the imager 307. The data processing includes peak detection, waveform processing such as filtering of mass profile data, or the like.

The storage controller 134 allows the storage device 140 to store various data acquired or processed in the step S5 (step S6). The transmitter 135 transmits various data acquired or processed in the step S5 from the wired communicator 110 to the information processing apparatus 2 (step S7) and ends the control processing.

When the information processing apparatus 2 is not connected to the wired communicator 110 in the step S2, the operation instructor 132 determines whether an operating instruction is acquired from the wireless communicator 120 (step S8). When the operating instruction is not acquired, the operation instructor 132 waits until the operating instruction is acquired. When the operating instruction is acquired, the operation instructor 132 gives the operating instruction to the firmware 220 (step S9). Thereafter, the data acquirer 133 performs the step S10 similarly to the step S5 (step S10). The storage controller 134 performs the step S11 similarly to the step S6 (step S11).

The data amount reducer 136 reduces the data amount of the mass profile data out of the data that is acquired or processed in the step S10 (step S12). The data amount is reduced by compression or thinning of the mass profile data. Here, the user can designate the mass range in the mass profile to be displayed in the GUI of the information processing apparatus 2 in advance. The percentage of thinning is determined according to the mass range and resolution of the mass profile to be displayed in the GUI of the information processing apparatus 2. In this case, it is possible to display the mass profile in the GUI of the information processing apparatus 2 in a required mass range without degrading resolution.

Thereafter, the transmitter 135 transmits various data from the wireless communicator 120 to the information processing apparatus 2 (step S13) and ends the control processing. Various data transmitted in the step S13 includes the data acquired in the step S10 except for the mass profile, and mass profile data the data amount of which is reduced in the step S12.

When a storage device (not shown) is connected to the wired communicator 110, the transmitter 135 may transmit various data to the storage device through the wired communicator 110 in the steps S6 and S11. In this case, various data that is acquired or processed in the step S5 and S10 can be stored in the storage device outside of the mass spectrometer 1.

### (3) MODIFIED EXAMPLE

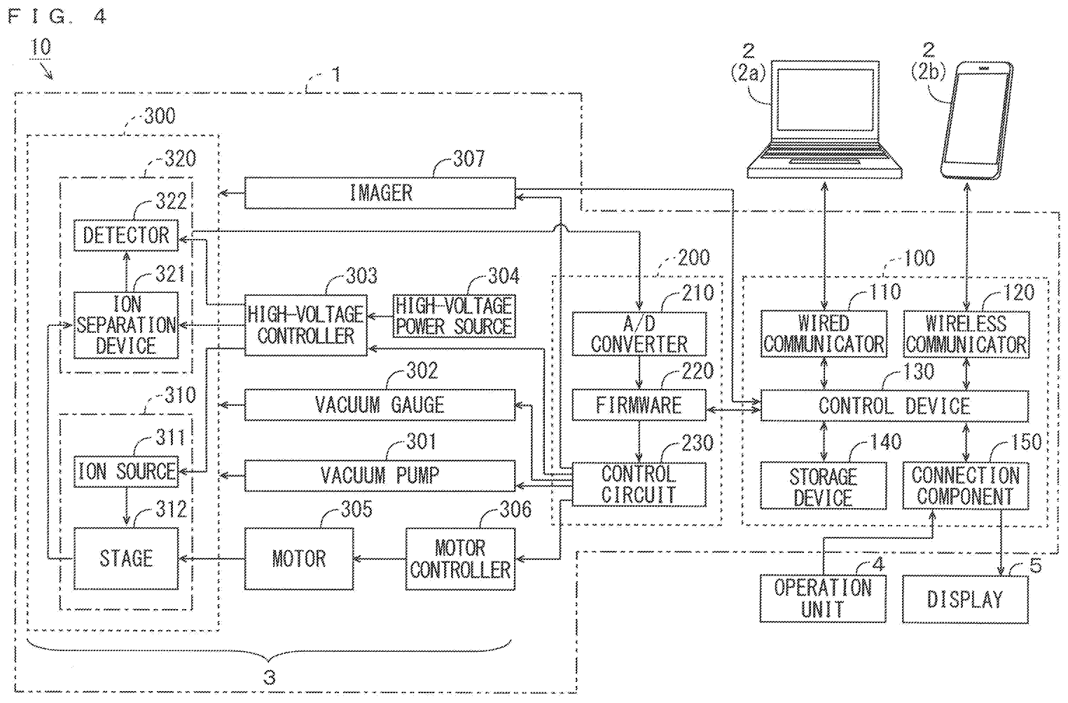

FIG. 4 is a diagram showing the configuration of a mass spectrometry system 10 according to a modified example. As shown in FIG. 4, in the modified example, the mass spectrometry system 10 further includes an operation unit 4 and a display 5. The operation unit 4 includes a keyboard and a pointing device such as a mouse, for example. The display 5 is a LCD (liquid crystal display) panel or an organic EL (Electroluminescence) panel, for example.

A server 100 of a mass spectrometer 1 further includes connection components 150. The connection components 150 are USB (Universal Serial Bus) ports, for example. The operation unit 4 and the display 5 are connected to the connection components 150. The user can give an operating instruction to a control device 130 through the connection component 150 by operating the operation unit 4. Further, a mass profile, an image of a sample or the like is displayed in the display 5 based on the data transmitted from the control device 130 through the connection component 150.

With this configuration, even when an information processing apparatus 2 is not connected to the mass spectrometer 1, the user can give an operating instruction to the mass spectrometer 1 and view the mass profile, an image of a sample or the like in the display 5.

Further, when a storage device (not shown) is connected to the connection component 150, a transmitter 135 may transmit various data to the storage device through the connection component 150 in the steps S6 and S11 of FIG. 3. In this case, various data acquired or processed in the steps S5 and S10 can be stored in the storage device outside of the mass spectrometer 1.

### (4) EFFECTS

In the mass spectrometry system 10 according to the present embodiment, the mass spectrometer 1 and the information processing apparatus 2 are connected to each other by the wired LAN or the wireless LAN. In this case, it is not necessary to use a virtual desktop or a web application, and an advanced GUI such as a multi-touch GUI can be realized by the information processing apparatus 2.

In the mass spectrometer 1, which one of the wired communicator 110 and the wireless communicator 120 the information processing apparatus 2 is connected to is determined by the connection determiner 131 Mass spectrometry of the sample is carried out by the analyzer 3 based on the operating instruction given by the connected information processing apparatus 2. The mass profile data of the sample based on the result of analysis performed by the analyzer 3 is acquired by the data acquirer 133. When the connection determiner 131 determines that the information processing apparatus 2 is connected to the wireless communicator 120, the data amount of the mass profile data acquired by the data acquirer 133 is reduced by the data amount reducer 136. The mass profile data, the data amount of which has been reduced by the data amount reducer 136, is transmitted to the information processing apparatus 2 through the wireless communicator 120 by the transmitter 135.

With this configuration, when the information processing apparatus 2 is connected to the mass spectrometer 1 through the wireless communicator 120, the data amount of the mass profile data transmitted from the mass spectrometer 1 to the information processing apparatus 2 is reduced. Therefore, even when a large volume of the mass profile data is acquired at a high speed by the data acquirer 133, the large volume of the mass profile data is prevented from being transmitted from the mass spectrometer 1 to the information processing apparatus 2. Therefore, even at a restricted communication speed of the wireless LAN, transmission of an operating instruction from the information processing apparatus 2 to the mass spectrometer 1 is not prevented. Thus, the information processing apparatus 2 can give an operating instruction to the mass spectrometer 1 at a high speed and in real time, and the mass spectrometer 1 can transmit the mass profile data to the information processing apparatus 2 at a high speed and in real time. As a result, the mass spectrometer 1 can be efficiently controlled by the information processing apparatus 2 connected to the wireless LAN.

Further, when the information processing apparatus 2 is moved during mass spectrometry, when the battery of the information processing apparatus 2 is excessively drained, etc., communication between the information processing apparatus 2 and the mass spectrometer 1 may be unexpectedly disconnected. Even in such a case, the operating instruction given by the information processing apparatus 2 to the mass spectrometer 1 and the data transmitted from the mass spectrometer 1 to the information processing apparatus 2 can be stored in the server 100. Thus, mass spectrometry can be continuously performed.

### (5) OTHER EMBODIMENTS

(a) While the two information processing apparatuses 2 (the one PC 2a and one mobile terminal 2b) are connected to the mass spectrometer 1 in the mass spectrometry system 10 of FIG. 1, the present invention is not limited to this. One information processing apparatus 2 may be connected to the mass spectrometer 1. The information processing apparatus 2 may be the PC 2a or the mobile terminal 2b. Further, in the mass spectrometry system 10 of FIG. 4, the information processing apparatus 2 does not have to be connected to the mass spectrometer 1.

(b) While the PC 2a is connected to the mass spectrometer 1 by the wired LAN, and the mobile terminal 2b is connected to the mass spectrometer 1 by the wireless LAN in the above-mentioned embodiment, the present invention is not limited to this. The PC 2a may be connected to the mass spectrometer 1 by the wireless LAN, and the mobile terminal 2b may be connected to the mass spectrometer 1 by the wired LAN. Alternatively, both of the PC 2a and the mobile terminal 2b may be connected to the mass spectrometer 1 by the wired LAN, and both of the PC 2a and the mobile terminal 2b may be connected to the mass spectrometer 1 by the wireless LAN.

(c) In the above-mentioned embodiment, when the information processing apparatus 2 is connected to the mass spectrometer 1 by the wired LAN, the processing of reducing the data amount is not performed on the mass profile data received by the information processing apparatus 2. However, the present invention is not limited to this. When the mobile terminal 2b is connected to the mass spectrometer 1 by the wired LAN as the information processing apparatus 2, the processing of reducing the data amount may be performed on the mass profile data received by the mobile terminal 2b.

With this configuration, even when a processing speed of the mobile terminal 2b is restricted, the information processing apparatus 2 can give an operating instruction to the mass spectrometer 1 at a high speed and in real time, and the mass spectrometer 1 can transmit the data to the information processing apparatus 2 at a high speed and in real time. Thus, the mass spectrometer 1 can be more efficiently controlled by the mobile terminal 2b.

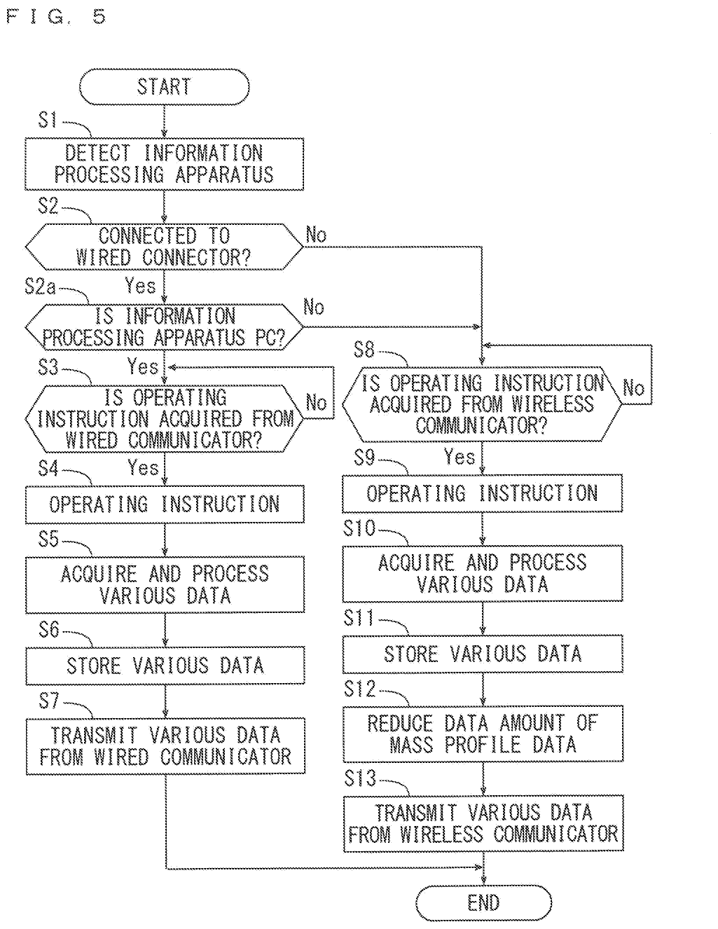

FIG. 5 is a flow chart showing the algorithm of control processing in other embodiments. The control processing of FIG. 5 is similar to the control processing of FIG. 3 except that the step S2a is provided between the step S2 and the step S3. In the control processing of FIG. 5, when the information processing apparatus 2 is connected to the wired LAN in the step S2, the connection determiner 131 determines whether the information processing apparatus 2 detected in the step S1 is the PC 2a (step S2a).

When it is determined that the information processing apparatus 2 is the PC 2a in the step S2a, the connection determiner 131 proceeds to the step S3. On the other hand, when it is determined that the information processing apparatus 2 is not the PC 2a in the step S2a, that is, when it is determined that the information processing apparatus 2 is the mobile terminal 2b, the connection determiner 131 proceeds to the step S8. The degree of a reduction in data amount in the step S12 when the process proceeds from the step S2 to the step S8 may be the same as or different from the degree of a reduction in data amount in the step S12 when the process proceeds from the step S2a to the step S8.

(d) While the processing of reducing the data amount is not performed on the data other than the mass profile data in the above-mentioned embodiment, the present invention is not limited to this. When the information processing apparatus 2 is connected to the mass spectrometer 1 by the wireless LAN, the processing of reducing the data amount may be performed on the data other than the mass profile data received by the information processing apparatus 2. The data other than the mass profile data may be image data produced by the imager 307, for example.

With this configuration, when the information processing apparatus is connected to the mass spectrometer 1 through the wireless communicator 120, the data amount of the image data transmitted from the mass spectrometer 1 to the information processing apparatus 2 is reduced. Thus, the information processing apparatus 2 can give an operating instruction to the mass spectrometer 1 at a high speed and in real time, and the mass spectrometer 1 can transmit image data to the information processing apparatus 2 at a high speed and in real time. As a result, the mass spectrometer 1 can be more efficiently controlled by the wirelessly connected information processing apparatus 2.

I/We claim:

1. A mass spectrometer that displays a mass profile based on mass profile data of a sample and is connectable to an information processing apparatus that analyzes the mass profile data, comprising:
a wired communicator that is connectable to the information processing apparatus by wired communication;
a wireless communicator that is connectable to the information processing apparatus by wireless communication;
a connection determiner that determines which one of the wired communicator and the wireless communicator the information processing apparatus is connected to;
an analyzer that carries out mass analysis of the sample based on an operating instruction given by the information processing apparatus;
a data acquirer that acquires mass profile data of the sample based on a result of analysis by the analyzer;
a data amount reducer that, when the connection determiner determines that the information processing apparatus is connected to the wireless communicator, reduces a data amount of the mass profile data acquired by the data acquirer; and
a transmitter that transmits the mass profile data, the data amount of which has been reduced by the data amount reducer, to the information processing apparatus through the wireless communicator.

2. The mass spectrometer according to claim 1, wherein the data amount reducer reduces the data amount by compressing or thinning the mass profile data.

3. The mass spectrometer according to claim 2, wherein
the information processing apparatus is configured to be able to designate a mass range of the mass profile to be displayed, and
the data amount reducer determines a percentage of thinning of the mass profile data based on the mass range designated by the information processing apparatus and resolution of a display of the mass profile.

4. The mass spectrometer according to claim 1, wherein
the information processing apparatus includes a PC (Personal Computer) or a mobile terminal.

5. The mass spectrometer according to claim 4, wherein
the connection determiner further determines whether the information processing apparatus connected to the wired communicator or the wireless communicator is the PC or the mobile terminal, and
the data amount reducer, when the connection determiner determines that the information processing apparatus is the mobile terminal, reduces the data amount of the mass profile data acquired by the data acquirer.

6. The mass spectrometer according to claim 4, wherein
the PC and the mobile terminal display a same GUI (Graphical User Interface) that receives a user's operation.

7. The mass spectrometer according to claim 6, wherein
the information processing apparatus restricts contents to be displayed in the GUI or contents of an operation to be received from the GUI according to performance of the information processing apparatus.

8. The mass spectrometer according to claim 6, wherein
the information processing apparatus includes a touch panel that receives a user's touch operation performed on the GUI.

9. The mass spectrometer according to claim 1, wherein
the analyzer further includes an imager that produces image data by imaging a sample,
the data acquirer further acquires image data produced by the imager,
the data amount reducer, when the connection determiner determines that the information processing apparatus is connected to the wireless communicator, further reduces a data amount of the image data acquired by the data acquirer, and
the transmitter further transmits the image data, the data amount of which has been reduced by the data amount reducer, to the information processing apparatus through the wireless communicator.

10. The mass spectrometer according to claim 1, further comprising a connection component to which an operation unit that receives a user's operation and a display that displays the mass profile based on the mass profile data of the sample are connectable, wherein
the analyzer carries out mass analysis of the sample based on the operation received by the operation unit, and
the connection component supplies the mass profile data acquired by the data acquirer to the display.

11. A mass spectrometry system comprising:
one or more information processing apparatuses that display a mass profile based on mass profile data of a sample and analyzes the mass profile data; and
the mass spectrometer according to claim 1 that is connected to the one or more information processing apparatuses by wired communication or wireless communication, performs mass analysis of the sample based on an operating instruction from one of the one or more information processing apparatuses, and transmits mass profile data of the sample based on a result of analysis to the information processing apparatus.

12. The mass spectrometry system according to claim 11, wherein
the connection between the mass spectrometer and the one or more information processing apparatuses is physically separated from an information processing apparatus outside of the mass spectrometry system.
